(19) United States
(12) Patent Application Publication
(10) Pub. No.: US 2022/0138692 A1
(43) Pub. Date: May 5, 2022

(54) SYSTEM AND METHOD FOR VIRTUAL PROJECT VISITS

(71) Applicant: Medecision, Inc., Dallas, TX (US)

(72) Inventors: Samuel Abraham, Orange, CA (US); Russell Holmes, Clermont, FL (US)

(73) Assignee: Medecision, Inc., Dallas, TX (US)

(21) Appl. No.: 17/178,947

(22) Filed: Feb. 18, 2021

Related U.S. Application Data
(60) Provisional application No. 63/107,220, filed on Oct. 29, 2020.

(51) Int. Cl. G06Q 10/10; G06Q 10/06; G06F 9/451

(52) U.S. Cl. CPC G06Q 10/103; G06F 9/451; G06Q 10/063114; G06Q 10/063118

(57) ABSTRACT

A system for operator interface processing for collaboration with a trusted circle of project personnel is disclosed. The system includes a project manager system that selects user interface controls for a project manager and to generate the project manager user interface controls at a main menu of a project manager operator interface. A project service provider system selects user interface controls for a project service provider to generate the project service provider user interface controls at a main menu of a project service provider operator interface. A project personnel system selects user interface controls for project personnel and to generate the project personnel user interface controls at a main menu of a project personnel operator interface. The project manager user interface controls, the project service provider user interface controls and the project personnel user interface controls are different from each other.

### RELATED APPLICATIONS

This application claims priority to and benefit of U.S. provisional patent application 63/107,220, SYSTEM AND METHOD FOR PROJECT COLLABORATION, filed Oct. 29, 2020, which is hereby incorporated by reference for all purposes as if set forth herein in its entirety.

### TECHNICAL FIELD

The present disclosure relates generally to presentation processing of a document and operator interface processing, and more specifically to a system and method for project collaboration that uses presentation processing of a document and operator interface processing to facilitate collaboration.

### BACKGROUND OF THE INVENTION

Project collaboration can be difficult to accomplish, particularly when there are multiple different service providers that have to be included in the collaborative efforts. Attempts to accomplish this collaboration between the project personnel and the service providers are generally unsuccessful.

### SUMMARY OF THE INVENTION

A system for operator interface processing for collaboration with a trusted circle of project personnel is disclosed. The system includes a project manager system operating on a processor and configured to select one or more predetermined user interface controls for a project manager and to generate the project manager user interface controls at a main menu of a project manager operator interface. A project service provider system operating on the processor is configured to select one or more predetermined user interface controls for a project service provider to generate the project service provider user interface controls at a main menu of a project service provider operator interface. A project personnel system operating on a processor is configured to select one or more predetermined user interface controls for project personnel and to generate the project personnel user interface controls at a main menu of a project personnel operator interface. The project manager user interface controls, the project service provider user interface controls and the project personnel user interface controls are different from each other.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for project collaboration, in accordance with an example embodiment of the present disclosure;

FIG. 2 is a diagram of a system for communication automation, in accordance with an example embodiment of the present disclosure;

FIG. 3 is a diagram of a system for tracking and reporting, in accordance with an example embodiment of the present disclosure;

FIG. 4 is a diagram of a system for project personnel operator interface and document presentation processing, in accordance with an example embodiment of the present disclosure;

FIG. 5 is a diagram of a system for project manager operator interface and document presentation processing, in accordance with an example embodiment of the present disclosure;

FIG. 6 is a diagram of a system for project service provider operator interface and document presentation processing, in accordance with an example embodiment of the present disclosure;

FIG. 7 is a diagram of an algorithm for defining document presentation and operator interface processing, in accordance with an example embodiment of the present disclosure;

FIG. 8 is a diagram of an algorithm for modifying project document presentation and operator interface processing, in accordance with an example embodiment of the present disclosure;

FIG. 9 is a diagram of an algorithm for modifying project manager document presentation and operator interface processing, in accordance with an example embodiment of the present disclosure; and

FIG. 10 is a diagram of an algorithm for modifying project service provider document presentation and operator interface processing, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

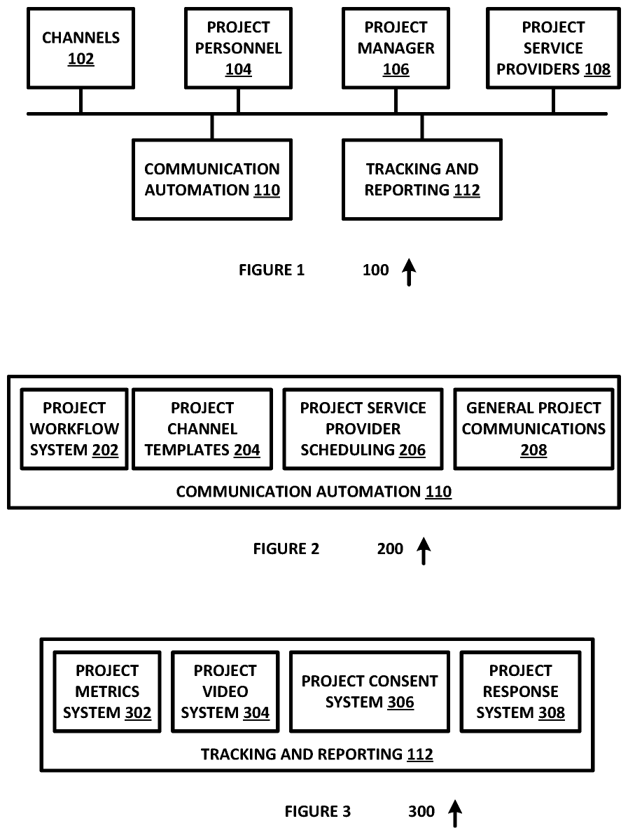

FIG. 1 is a diagram of a system 100 for project collaboration, in accordance with an example embodiment of the present disclosure. System 100 includes channels system 102, project personnel system 104, project manager system 106, project service providers system 108, communication automation system 110 and tracking and reporting system 112, each of which can be implemented in hardware or a suitable combination of hardware and software.

Channels system 102 can be implemented as one or more algorithms that are retrieved from storage in a data memory device and installed into working memory of a processor, where they modify the operation of the processor to perform the functions of identifying one or more data communications channels for project-related communications. In one example embodiment, a project can include project personnel who are on-site or who otherwise work on a project on a regular basis, a project manager who is not on site but who provides project management assistance from a remote location, and project service providers who provide project services at the project site or remote from the project site for a plurality of different projects. In this example embodiment, the project personnel can be provided with presentation processing of a document and operator interface processing that is adapted to the specific needs of the project personnel by the project manager. The project manager can use one or more templates as a starting point and can modify the templates to optimize the presentation processing of a document and operator interface processing for project personnel, such as by using the selected communications channel and formatting the presentation processing of a document over the communications channel and operator interface processing over the communications channel.

For example, if the selected communications channel is a text message, project personnel will expect important communications to be provided by text message, and will need to have presentation processing of documents for viewing by text message and operator interface processing for the text message communications channel. System 100 and channels system 102 are configured to allow the project manager to select a text message template and to modify data that is to be displayed in the text message and operator interface controls that are used for text message communications, such as generating hyperlinks for selected types of documents, user controls to allow the user to respond to text messages with simple inputs (e.g. enter 1 to proceed, 2 for a reminder in 10 minutes, or 3 to decline) and other suitable document presentation processing and operator interface processing.

Project managers can select templates for responses that provide operator controls at a main menu, and can modify the controls based on project guidance. Likewise, project personnel can modify the controls. Project service providers can have a more limited amount of control over their operator interface and document presentation controls, and can also have operator interface settings and document presentation settings that are different from either the project personnel settings or the project manager settings.

In addition to text messaging and controls with hyperlinks to documents, other suitable user interface controls and document presentation processing can be used. For example, a web browser interface can be used that includes a main menu with predetermined operator controls and document presentation processing to allow all necessary information required for communications to be presented at a main menu, to allow the user of the web browser interface to communicate with other interfaces, such as the text message interface. In this manner, the user does not need to access a text message device in order to communicate by text messages with the text message interface. Likewise, speech to text conversion document processing can be used for a telephone user interface, a smart watch interface with restricted text message functionality can be provided as an option, augmented reality headsets, head-mounted optical interfaces and other suitable devices can also or alternatively be supported. Video communications channels can also be used alone or in combination with other communications channels. In one example embodiment, a television data channel can be used to display video and text messaging can be used to enter commands, or other suitable combinations of devices can also or alternatively be used.

Project personnel system 104 can be implemented as one or more algorithms that are retrieved from storage in a data memory device and installed into working memory of a processor, where they modify the operation of the processor to perform the functions of presentation processing of a document for project personnel and operator interface processing for project personnel. In one example embodiment, project personnel system 104 can interface with channels system 102, project manager system 106, project service providers system 108, communication automation system 110, tracking and reporting system 112 and other suitable systems to facilitate presentation processing of a document for project personnel and operator interface processing for project personnel. In this example embodiment, a document such as a project timeline can be generated that has been processed for project personnel system 104, such as to show timeline events that require data input or actions to be performed by project personnel. Further to this example embodiment, timeline events for project managers or project service providers can be de-emphasized or omitted, so as to facilitate review of the timeline events. Likewise, presentation processing of other documents can be performed, such as test reports, project profiles, project histories, case studies of relevance to the project, guidelines for project personnel and other suitable documents.

Project manager system 106 can be implemented as one or more algorithms that are retrieved from storage in a data memory device and installed into working memory of a processor, where they modify the operation of the processor to perform the functions of presentation processing of a document for a project manager and operator interface processing for a project manager, as well as implementing initial configurations of presentation processing of a document for project personnel and operator interface processing for project personnel, and presentation processing of a document for a project service provider and operator interface processing for a project service provider. In one example embodiment, project manager system 106 can interface with channels system 102, project personnel system 104, project service providers system 108, communication automation system 110, tracking and reporting system 112 and other suitable systems to facilitate presentation processing of a document for project personnel and operator interface processing for project personnel. In this example embodiment, a document such as a project timeline can be generated that has been processed for project manager system 106, such as to show timeline events that require data input or actions to be performed by the project manager. Further to this example embodiment, timeline events for project personnel or project service providers can be de-emphasized or omitted, so as to facilitate review of the timeline events. Likewise, presentation processing of other documents can be performed, such as test reports, project profiles, project histories, case studies of relevance to the project, guidelines for project personnel and other suitable documents. The project manager can manage a large number of different projects in this manner, and can readily review the status of the project from a main menu without having to spend time navigating through different menus to determine whether any actions are required.

Project service providers system 108 can be implemented as one or more algorithms that are retrieved from storage in a data memory device and installed into working memory of a processor, where they modify the operation of the processor to perform the functions of presentation processing of a document for project service providers and operator interface processing for project service providers. In one example embodiment, project service provider system 108 can interface with channels system 102, project manager system 106, project personnel system 104, communication automation system 110, tracking and reporting system 112 and other suitable systems to facilitate presentation processing of a document for project service providers and operator interface processing for project service providers. In this example embodiment, a document such as a project timeline can be generated that has been processed for project service provider system 108, such as to show timeline events that require data input or actions to be performed by a product service provider. In this example embodiment, timeline events for project managers or project personnel can be de-emphasized or omitted, so as to facilitate review of the timeline events. Likewise, presentation processing of other documents can be performed, such as test reports, project profiles, project histories, case studies of relevance to the project, guidelines for project personnel and other suitable documents. The service provider can provide services to a large number of different projects in this manner, and can readily review the status of the project from a main menu without having to spend time navigating through different menus to determine whether any actions are required.

Communication automation system 110 can be implemented as one or more algorithms that are retrieved from storage in a data memory device and installed into working memory of a processor, where they modify the operation of the processor to perform the functions of automating communications between project personnel system 104, project manager system 106 and project service provider system 108. In one example embodiment, a communications channel can be invoked from a main menu or operator interface, to eliminate the need for a communications channel to be identified for specific project personnel, project managers or project service providers. Likewise, presentation processing of a document for a communications channel and operator interface processing for a communications channel can also be implemented by communication automation system 110, and specific modifications for a project personnel system 104, project manager system 106 and project service provider system 108 for a specific project can also or alternatively be implemented.

Tracking and reporting system 112 can be implemented as one or more algorithms that are retrieved from storage in a data memory device and installed into working memory of a processor, where they modify the operation of the processor to perform the functions of tracking and reporting documents, virtual project visits and other project-related activities, using presentation processing of document and operator interface processing for project personnel system 104, project manager system 106 and project service provider system 108. In one example embodiment, a project can include a number of action items, such as to schedule a test, to perform the test, to report the test results and to evaluate the test results. The presentation processing of documents and operator interface processing for project personnel system 104, project manager system 106 and project service provider system 108 can be different for each stage, and can be initially configured by project manager system 106 using templates for presentation processing of documents and operator interface processing. The templates for project personnel system 104, project manager system 106 and project service provider system 108 can be modified as needed, such as to perform presentation processing of documents for project personnel system 104 that is different from the presentation processing of documents that is performed for project manager system 106 and project service provider system 108.

For example, if the project service provider system 108 is used to order the test, presentation processing is performed for the test order form to populate the request with project-specific details, but the presentation processing of the test order form for project personnel system 104 may only require approval and selection of a time for the tests, without any additional details regarding what tests have been ordered. In this manner, the operator of project personnel system 104 can quickly approve and schedule the test without having to read though unimportant test selection and specification details. Likewise, the project manager system 106 may only require status information associated with the test, such as to indicate that the test has been ordered by project service provider system 108 and is awaiting approval and scheduling by project personnel system 104. Additional details regarding the tests may be unnecessary and distracting for the operator of project manager system 106, and by performing document presentation processing to show only the status of the test at the main menu, the amount of data processing and time required to perform the data processing can be substantially reduced. Likewise, operator interface processing can be performed to generate controls that can be configured based upon status, such as to generate test order controls for project service provider system 108, test status controls for project manager system 106, test approval controls for project personnel system 104 and other suitable controls. In this manner, the operator interface processing for each system is optimized to reduce the amount of information and to generate a main menu that presents the information that is required without additional unnecessary information, and without the need for a user to navigate through additional user interface menus, directories, documents and so forth.

In addition to tests, tracking and reporting system 112 can be used for project profiles (such as to track project profile completions, changes or updates), project histories (such as to track project history completions, changes or updates), case studies of relevance to the project (such as to track the review of case studies and to obtain feedback as to the relevance of the case study to the project), guidelines for project personnel and other suitable documents.

FIG. 2 is a diagram of a system 200 for communication automation, in accordance with an example embodiment of the present disclosure. System 200 includes communication automation system 110 and project workflow system 202, project channel templates 204, project service provider scheduling system 206 and general project communications system 208, each of which can be implemented in hardware or a suitable combination of hardware and software.

Project workflow system 202 can be implemented as one or more algorithms that are retrieved from storage in a data memory device and installed into working memory of a processor, where they modify the operation of the processor to perform the functions of modifying the presentation processing of documents and operator interface processing for project personnel system 104, project manager system 106 and project service provider system 108 as a function of a workflow or changes to a workflow. For example, in the testing workflow scenario discussed above, the initial workflow is for the project service provider system 108 to order the test, the project manager system 106 to track the status of the order until it is approved and scheduled by project personnel system 104, and then for project manager system 106 to track the status of the test until it is completed, after which presentation processing of the test results is performed to present the test results to project personnel system 104 (e.g. pass or fail), project manager system 106 (e.g. test results reported) and project service provider system 108 (e.g. specific test data). However, a test may need to be rescheduled, a project development may require the test to be modified or other modifications to the workflow may be needed. Project workflow system 202 performs the functions of presentation processing of documents and operator interface processing for project personnel system 104, project manager system 106 and project service provider system 108 as a function of such workflows or changes to workflows. In one example embodiment, presentation processing of documents and operator interface processing is performed for project workflow system 202 as a function of changes to the workflow that are implemented by project personnel system 104, project manager system 106 and project service provider system 108, such as to generate a user interface main menu with presentation processing of documents that are associated with the change and operator interface controls that are necessitated by the change, to eliminate the need for an operator to navigate through menus, directories and documents to analyze the change and determine what documents are needed and what controls need to be used.

In addition to tests, project workflow system 202 can be used for project profiles (such as for project profile workflow completions, changes or updates), project histories (such as to track project history workflow completions, changes or updates), case studies of relevance to the project (such as to track the review of case studies and to obtain feedback as to the relevance of the case study to the project), guidelines for project personnel and other suitable documents.

Project channel templates 204 can be implemented as one or more algorithms that are retrieved from storage in a data memory device and installed into working memory of a processor, where they modify the operation of the processor to perform the functions of modifying the presentation processing of documents and operator interface processing for project personnel system 104, project manager system 106 and project service provider system 108 as a function of a channel selection or changes to a channel selection. For example, in the testing workflow scenario discussed above, the initial channel selection for the project service provider system 108 to order the test and for the project manager system 106 to track the status of the order until it is approved can be a web portal, and for the test to be scheduled by project personnel system 104 can be a text message. However, a test may need to be rescheduled, a project development may require the test to be modified or other modifications to the test may be needed, which can require a text message to be sent to project service provider system 108. Project channel templates 204 can be used to implement the original channel selections, to implement changes to the channel selections or for other suitable purposes. In addition, project-specific changes to the channels and other suitable functions can be made and stored by project channel templates 204.

Project service provider scheduling system 206 can be implemented as one or more algorithms that are retrieved from storage in a data memory device and installed into working memory of a processor, where they modify the operation of the processor to perform the functions of scheduling project service provider virtual or physical visits. In one example embodiment, a project service provider may need to determine whether a virtual or physical project visit is required. In this example, project manager system 106 can use a template to generate an initial request to project service provider system 108 that performs presentation processing of project-related documents and which generates an operator interface for project service provider system 108 to either schedule a virtual visit, a physical visit or to request additional information. Likewise, project service provider scheduling system 206 can be used to implement project-specific changes to templates, to perform follow-on physical visits after virtual visits, to request virtual or physical visits by other project service providers or to perform other suitable functions.

General project communications system 208 can be implemented as one or more algorithms that are retrieved from storage in a data memory device and installed into working memory of a processor, where they modify the operation of the processor to perform the functions of providing document presentation processing and operator control configurations for general project communications for project personnel system 104, project manager system 106 and project service provider system 108. In one example embodiment, general project communications can include communications that are not project specific but which are still relevant to a project, such as changes to holiday schedules, weather closures, natural disaster notices and so forth. General project communications system 208 can configure document presentation processing and operator control configurations based on configuration data at project personnel system 104, project manager system 106 and project service provider system 108 or other suitable data.

FIG. 3 is a diagram of a system 300 for tracking and reporting, in accordance with an example embodiment of the present disclosure. System 300 includes tracking and reporting system 112 and project metrics system 302, project video system 304, project consent system 306 and project response system 308, each of which can be implemented in hardware or a suitable combination of hardware and software.

Project metrics system 302 can be implemented as one or more algorithms that are retrieved from storage in a data memory device and installed into working memory of a processor, where they modify the operation of the processor to perform the functions of providing document presentation processing and operator control configurations for project metrics for project personnel system 104, project manager system 106 and project service provider system 108. In one example embodiment, project metrics can include project-specific data that is required by project personnel system 104, project manager system 106 and project service provider system 108 or other suitable data. For example, project personnel system 104 can perform presentation processing to show a number of days since a project visit from a project service provider, to allow the operator to determine whether another visit is needed. Project specific data such as a number of items consumed by the project can be displayed by presentation processing, and operator controls can be generated to prompt project personnel to enter a number of items consumed that day. Likewise, project-specific metrics for project manager system 106 can include a number of days that project personnel have not accessed project personnel system 104, inconsistent project metrics that require further investigation or other suitable data. Project-specific metrics for project service provider system 108 can include project-specific information of relevance to the service provider or requests for additional project-specific data. In this manner, document presentation processing of project metrics and operator controls associated with the generation and use of project metrics can be provided.

Project video system 304 can be implemented as one or more algorithms that are retrieved from storage in a data memory device and installed into working memory of a processor, where they modify the operation of the processor to perform the functions of creating and storing project-related video. In one example embodiment, a project-related video can have limited distribution, such as to limit access to the project-related video to project personnel and specific service providers. In this example embodiment, presentation processing by project video system 304 can be used to limit the different project service provider systems 108 that are even notified of the existence of a project-related video, to protect against inadvertent disclosure of the project-related video to unauthorized personnel. Likewise, project video system 304 can be used to grant limited access to project video in response to controls received from project personnel system 104, project manager system 106 or project service provider system 108, to perform presentation processing and operator interface processing for the video and to perform other suitable functions.

Project consent system 306 can be implemented as one or more algorithms that are retrieved from storage in a data memory device and installed into working memory of a processor, where they modify the operation of the processor to perform the functions of obtaining and storing project-related consents. In one example embodiment, a project-related consent can be required for access to project information by project personnel, project service providers may be required to accept access restrictions on project-related information or other suitable project-related consent processing can be provided. In this example embodiment, presentation processing by project consent system 306 can be used to generate specific consent forms for different project service provider systems 108, to protect against inadvertent disclosure of the project-related information to unauthorized personnel and for other suitable purposes. Likewise, project consent system 306 can be used to grant limited access to project data in response to controls received from project personnel system 104, project manager system 106 or project service provider system 108, to perform presentation processing and operator interface processing for the project data and to perform other suitable functions.

Project response system 308 can be implemented as one or more algorithms that are retrieved from storage in a data memory device and installed into working memory of a processor, where they modify the operation of the processor to perform the functions of tracking response data for project personnel system 104, project manager system 106 or project service provider system 108. In one example embodiment, a project-related consent can be required for access to project information by project personnel, project service providers may be required to accept access restrictions on project-related information or other suitable project-related consent processing can be provided. In this example embodiment, presentation processing by project response system 308 can be used to generate specific response forms for different project service provider systems 108, to provide specific response data and for other suitable purposes. Likewise, project response system 308 can be used to provide responses to queries that include project specific data in response to controls received from project personnel system 104, project manager system 106 or project service provider system 108, to perform presentation processing and operator interface processing for the project-specific response data and to perform other suitable functions.

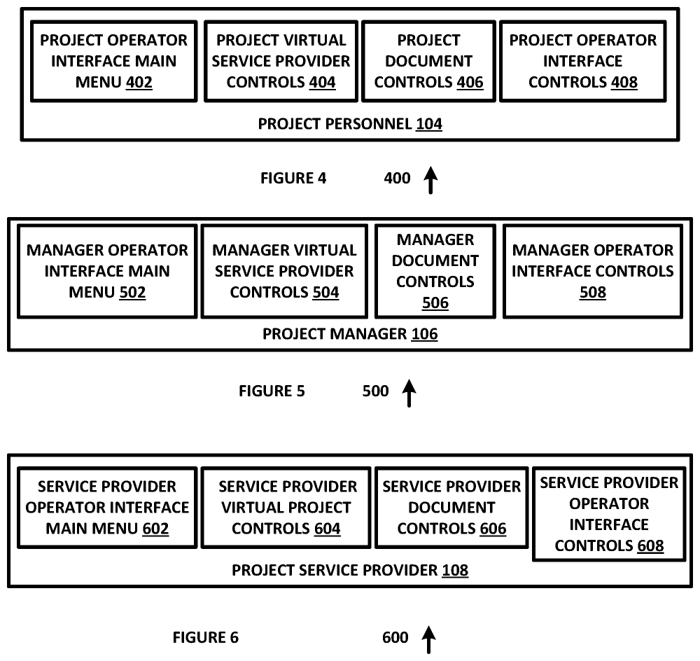

FIG. 4 is a diagram of a system 400 for project personnel operator interface and document presentation processing, in accordance with an example embodiment of the present disclosure. System 400 includes project personnel system 104 and project operator interface main menu 402, project virtual service provider controls 404, project document controls 406 and project operator interface controls 408, each of which can be implemented in hardware or a suitable combination of hardware and software.

Project operator interface main menu 402 can be implemented as one or more algorithms that are retrieved from storage in a data memory device and installed into working memory of a processor, where they modify the operation of the processor to perform the functions of generating a main menu with specific functionality for project personnel. In one example embodiment, project operator interface main menu 402 can include menu selections received from project manager system 106 that are derived from templates that are customized for a specific project, such as to present the most relevant menu selections for a current stage in a project workflow. For example, the project workflow can be at a testing stage, and the main menu selections can be limited to testing-related controls, to facilitate the scheduling and review of test results by project personnel. Likewise, other suitable functions can also or alternatively be provided, such as project operator interface main menu functions coordinated through communication automation system 110 and its associated sub-systems, tracking and reporting system 112 and its associated sub-systems and other suitable functionality.

Project virtual service provider controls 404 can be implemented as one or more algorithms that are retrieved from storage in a data memory device and installed into working memory of a processor, where they modify the operation of the processor to perform the functions of generating operating interface controls with specific functionality for project personnel associated with virtual service providers. In one example embodiment, project virtual service provider controls 404 can include menu selections received from project manager system 106 that are derived from templates that are customized for a specific virtual service provider, such as to present the most relevant menu selections for a virtual service provider that is currently engaging in a virtual project visit. For example, the virtual project visit can require the virtual service provider to see specific data storage drives or to operate specific local instrumentation. Likewise, other suitable functions can also or alternatively be provided, such as project personnel virtual service main menu functions coordinated through communication automation system 110 and its associated sub-systems, tracking and reporting system 112 and its associated sub-systems and other suitable functionality.

Project document controls 406 can be implemented as one or more algorithms that are retrieved from storage in a data memory device and installed into working memory of a processor, where they modify the operation of the processor to perform the functions of generating document controls for presentation processing of documents and operator interface processing for project personnel. In one example embodiment, project document controls 406 can receive template document controls from project manager system 106, can modify the template document controls in response to other changes to project personnel system 104 or associated systems, and can perform other suitable functions.

Project operator interface controls 408 can be implemented as one or more algorithms that are retrieved from storage in a data memory device and installed into working memory of a processor, where they modify the operation of the processor to perform the functions of generating operator interface controls for presentation processing of documents and operator interface processing for project personnel. In one example embodiment, project operator interface controls 408 can receive template operator interface controls from project manager system 106, can modify the template operator interface controls and can perform other suitable functions.

FIG. 5 is a diagram of a system 500 for project manager operator interface and document presentation processing, in accordance with an example embodiment of the present disclosure. System 500 includes project manager system 106 and manager operator interface main menu 502, manager virtual service provider controls 504, manager document controls 506 and manager operator interface controls 508, each of which can be implemented in hardware or a suitable combination of hardware and software.

Manager operator interface main menu 502 can be implemented as one or more algorithms that are retrieved from storage in a data memory device and installed into working memory of a processor, where they modify the operation of the processor to perform the functions of generating a main menu with specific functionality for project managers. In one example embodiment, manager operator interface main menu 502 can include menu selections that are derived from templates that are customized for a specific project, such as to present the most relevant menu selections for a current stage in a project workflow. For example, the project workflow can be at a testing stage, and the main menu selections can be limited to testing-related controls, to facilitate the scheduling and review of test results by a project manager. Likewise, other suitable functions can also or alternatively be provided, such as manager operator interface main menu functions coordinated through communication automation system 110 and its associated sub-systems, tracking and reporting system 112 and its associated sub-systems and other suitable functionality.

Manager virtual service provider controls 504 can be implemented as one or more algorithms that are retrieved from storage in a data memory device and installed into working memory of a processor, where they modify the operation of the processor to perform the functions of generating operating interface controls with specific functionality for management of service providers. In one example embodiment, manager virtual service provider controls 504 can include menu selections that are derived from templates that are customized for a specific virtual service provider, such as to present the most relevant menu selections for a virtual service provider that is currently engaging in a virtual project visit. For example, the virtual project visit can require the virtual service provider to see specific drives or to operate specific local instrumentation. Likewise, other suitable functions can also or alternatively be provided, such as project personnel virtual service main menu functions coordinated through communication automation system 110 and its associated sub-systems, tracking and reporting system 112 and its associated sub-systems and other suitable functionality.

Manager document controls 506 can be implemented as one or more algorithms that are retrieved from storage in a data memory device and installed into working memory of a processor, where they modify the operation of the processor to perform the functions of generating document controls for presentation processing of documents and operator interface processing for project managers. In one example embodiment, manager document controls 506 can receive template document controls, can modify the template document controls and can perform other suitable functions.

Manager operator interface controls 508 can be implemented as one or more algorithms that are retrieved from storage in a data memory device and installed into working memory of a processor, where they modify the operation of the processor to perform the functions of generating operator interface controls for presentation processing of documents and operator interface processing for project managers. In one example embodiment, manager operator interface controls 508 can receive template operator interface controls, can modify the template operator interface controls and can perform other suitable functions.

FIG. 6 is a diagram of a system 600 for project service provider operator interface and document presentation processing, in accordance with an example embodiment of the present disclosure. System 600 includes project service provider system 108 and service provider operator interface main menu 602, service provider virtual project controls 604, service provider document controls 606 and service provider operator interface controls 608, each of which can be implemented in hardware or a suitable combination of hardware and software.

Service provider operator interface main menu 602 can be implemented as one or more algorithms that are retrieved from storage in a data memory device and installed into working memory of a processor, where they modify the operation of the processor to perform the functions of generating a main menu with specific functionality for service provider personnel. In one example embodiment, service provider operator interface main menu 602 can include menu selections received from project manager system 106 that are derived from templates that are customized for a specific project, such as to present the most relevant menu selections for a current stage in a project workflow. For example, the project workflow can be at a testing stage, and the main menu selections can be limited to testing-related controls, to facilitate the scheduling and review of test results by service provider personnel. Likewise, other suitable functions can also or alternatively be provided, such as service provider operator interface main menu functions coordinated through communication automation system 110 and its associated sub-systems, tracking and reporting system 112 and its associated sub-systems and other suitable functionality.

Service provider virtual project controls 604 can be implemented as one or more algorithms that are retrieved from storage in a data memory device and installed into working memory of a processor, where they modify the operation of the processor to perform the functions of generating operating interface controls with specific functionality for service providers. In one example embodiment, service provider virtual service provider controls 604 can include menu selections received from project manager system 106 that are derived from templates that are customized for a specific service provider, such as to present the most relevant menu selections for a service provider that is currently engaging in a virtual project visit. For example, the virtual project visit can require the service provider to see specific drives or to operate specific local instrumentation. Likewise, other suitable functions can also or alternatively be provided, such as service provider virtual service main menu functions coordinated through communication automation system 110 and its associated sub-systems, tracking and reporting system 112 and its associated sub-systems and other suitable functionality.

Service provider document controls 606 can be implemented as one or more algorithms that are retrieved from storage in a data memory device and installed into working memory of a processor, where they modify the operation of the processor to perform the functions of generating document controls for presentation processing of documents and operator interface processing for service providers. In one example embodiment, service provider document controls 606 can receive template document controls from project manager system 106, can modify the template document controls and can perform other suitable functions.

Service provider operator interface controls 608 can be implemented as one or more algorithms that are retrieved from storage in a data memory device and installed into working memory of a processor, where they modify the operation of the processor to perform the functions of generating operator interface controls for presentation processing of documents and operator interface processing for service providers. In one example embodiment, service provider operator interface controls 608 can receive template operator interface controls from project manager system 106, can modify the template operator interface controls and can perform other suitable functions.

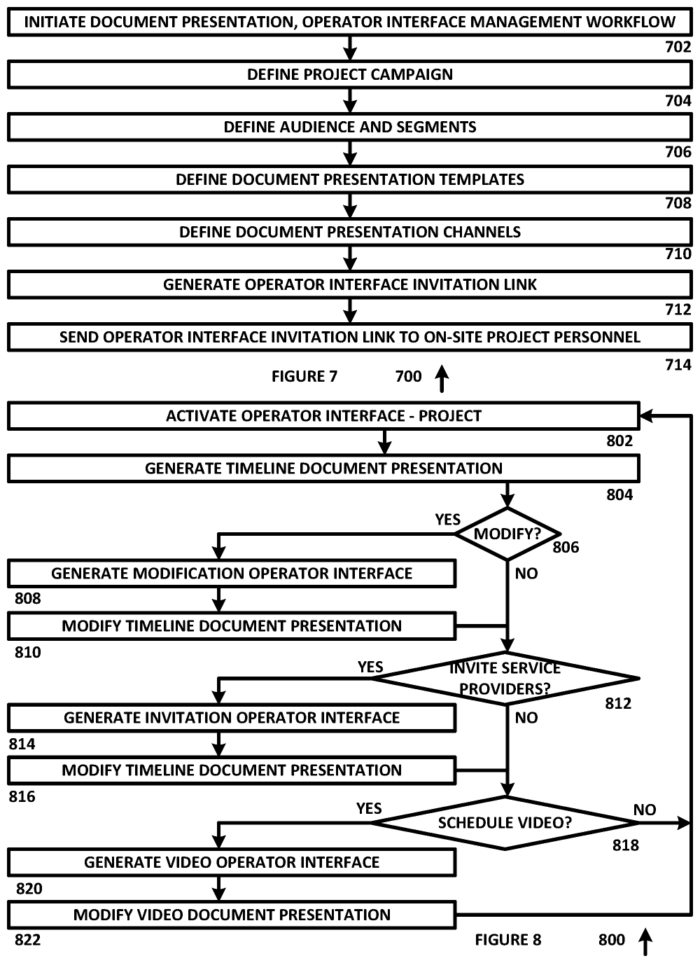

FIG. 7 is a diagram of an algorithm 700 for defining document presentation and operator interface processing, in accordance with an example embodiment of the present disclosure. Algorithm 700 can be implemented in hardware or a suitable combination of hardware and software.

Algorithm 700 begins at 702, where a document presentation and operator interface management workflow is initiated. In one example embodiment, the document presentation and operator interface management workflow can be initiated by a project manager that oversees a large number of similar projects, such as construction projects, research projects, health-related projects and other suitable projects. The algorithm then proceeds to 704.

At 704, a project campaign is defined. In one example embodiment, project campaigns can be based on a project campaign template that includes document presentation processing templates, operator interface processing templates and other suitable data associated with predetermined phases for a workflow. In this example embodiment, the campaign can be associated with predetermined construction projects, research projects, health-related projects and other suitable projects that have known phases based on best practices, such as to perform predetermined preliminary tests, to perform predetermined follow-up tests, to provide predetermined materials to project personnel and other suitable phases that are part of a project campaign. The algorithm then proceeds to 706.

At 706, audience and segments are defined. In one example embodiment, the audience can include project personnel, project managers, service providers and other suitable audience members. The segments can include segments for the different audience members or other suitable segments associated with a project. The algorithm then proceeds to 708.

At 708, document presentation templates are defined. In one example embodiment, the document presentation templates can be associated with the defined project campaign, the defined audience, the define segments or other suitable parameters, in order to provide presentation processing of documents, operator interface processing for documents and other suitable functions. The algorithm then proceeds to 710.

At 710, document presentation channels are defined. In one example embodiment, the document presentation channels can be associated with the defined project campaign, the defined audience, the define segments or other suitable parameters, in order to provide presentation processing of documents, operator interface processing for documents and other suitable functions. The algorithm then proceeds to 712.

At 712, operator interface invitation links are generated. In one example embodiment, the operator interface invitation links can be sent to specific project personnel, managers and service providers, can be sent to lead project personnel, managers and service providers for subsequent invitation, or in other suitable manners. The algorithm then proceeds to 714.

At 714, an operator interface invitation link is sent to on-site project personnel. In one example embodiment the on-site personnel can be personnel other than the lead project personnel who are associated with a project. The algorithm then terminates.

In operation, algorithm 700 defines document presentation and operator interface processing, such as for use in a system for project collaboration or in other suitable applications. Although algorithm 700 is shown as a flow chart, it can also or alternatively be implemented using a state diagram, a ladder diagram, object oriented programming or other suitable programming paradigms, on one or more special purpose processors or in other suitable manners.

FIG. 8 is a diagram of an algorithm 800 for modifying project document presentation and operator interface processing, in accordance with an example embodiment of the present disclosure. Algorithm 800 can be implemented in hardware or a suitable combination of hardware and software.

Algorithm 800 begins at 802, where an operator interface for a project is activated. In one example embodiment, the operator interface can include a main menu with predetermined user interface controls and predetermined data that allow the user to obtain specific information that is of primary importance for the project. The algorithm then proceeds to 804.

At 804, a timeline document presentation is generated. In one example embodiment, the timeline document presentation can include only those timeline events that are relevant to the project personnel, such as any event that requires the project personnel to respond, to act or to perform other suitable functions. The algorithm then proceeds to 806.

At 806, it is determined whether a command has been received to modify the timeline. In one example embodiment, the command can be used to modify a timeline presentation, a timeline operator control or other suitable modifications. If it is determined that a modification is required, the algorithm proceeds to 808, otherwise the algorithm proceeds to 812.

At 808, an operator interface modification control is generated. In one example embodiment, the operator interface modification control can add a control that the operator would like to have present on a timeline main menu, such as to facilitate review and interaction with the timeline. The algorithm then proceeds to 810.

At 810, a timeline document presentation is modified. In one example embodiment, the timeline document presentation modification can modify the data presented in the timeline that the operator would like to have present on a timeline main menu, such as to facilitate review and interaction with the timeline. The algorithm then proceeds to 812.

At 812, it is determined whether to invite a service provider. In one example embodiment, the timeline can indicate points at which a service provider will be needed, a service provider prompt can be generated or other suitable functions can be used to determine whether a service provider should be invited. A suggested service provider can also be identified. If it is determined that a service provider is to be invited, the algorithm proceed to 814, otherwise the algorithm proceeds to 818.

At 814, an operator interface invitation control is generated. In one example embodiment, the operator interface invitation control can be generated at a main menu and can include a predetermined service provider, although a second control for selecting a service provider from a menu, for searching for a service provider or for otherwise identifying a service provider to be invited can also or alternatively be generated. The algorithm then proceeds to 816.

At 816, the timeline document presentation is modified to reflect the invited service provider and to display additional related information, such as whether the invitation has been accepted, whether a different time has been proposed, any messages provided by the service provider and so forth. The algorithm then proceeds to 818.

At 818, it is determined whether to schedule a video or virtual service provider visit. If it is determined that a video or virtual visit is selected, the algorithm proceeds to 820, otherwise the algorithm returns to 802.

At 820, a link for an operator interface for a service provider to engage in a video or virtual visit is generated. In one example embodiment, the link can include identifying information for a specific service provider, and can include additional authentication, security, scheduling or other suitable functionality. The algorithm then proceeds to 822.

At 822, the video document presentation is modified. In one example embodiment, the video document presentation can include one or more operator controls or presentation processing components that are specific to the selected service provider, such as to include information associated with that service provider, the virtual or video visit or other suitable data. The algorithm then returns to 802.

In operation, algorithm 800 modifies project document presentation and operator interface processing, such as for use in a system for project collaboration or in other suitable applications. Although algorithm 800 is shown as a flow chart, it can also or alternatively be implemented using a state diagram, a ladder diagram, object oriented programming or other suitable programming paradigms, on one or more special purpose processors or in other suitable manners

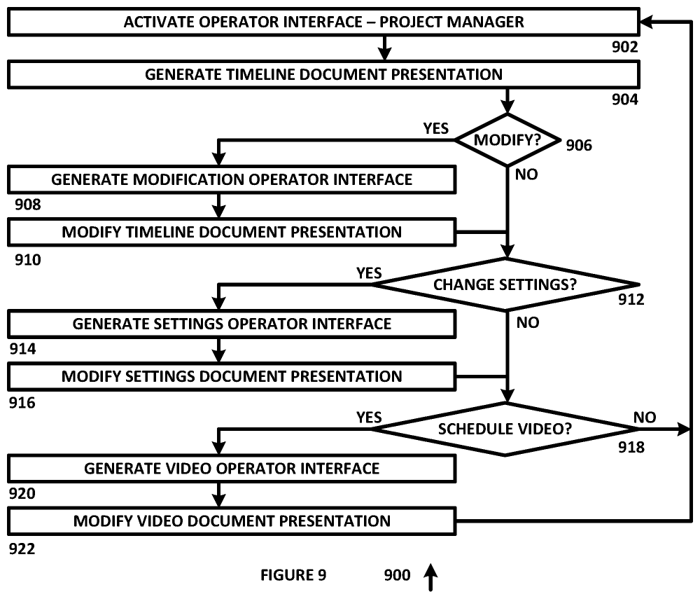

FIG. 9 is a diagram of an algorithm 900 for modifying project manager document presentation and operator interface processing, in accordance with an example embodiment of the present disclosure. Algorithm 900 can be implemented in hardware or a suitable combination of hardware and software.

Algorithm 900 begins at 902, where an operator interface for a project manager is activated. In one example embodiment, the operator interface can include a main menu with predetermined user interface controls and predetermined data that allow the user to obtain specific information that is of primary importance for the project manager. The algorithm then proceeds to 904.

At 904, a timeline document presentation is generated. In one example embodiment, the timeline document presentation can include only those timeline events that are relevant to the project manager, such as any event that requires the project manager to respond, to act or to perform other suitable functions. The algorithm then proceeds to 906.

At 906, it is determined whether a command has been received to modify the timeline. In one example embodiment, the command can be used to modify a timeline presentation, a timeline operator control or other suitable modifications. If it is determined that a modification is required, the algorithm proceeds to 908, otherwise the algorithm proceeds to 912.

At 908, an operator interface modification control is generated. In one example embodiment, the operator interface modification control can add a control that the operator would like to have present on a timeline main menu, such as to facilitate review and interaction with the timeline. The algorithm then proceeds to 910.

At 910, a timeline document presentation is modified. In one example embodiment, the timeline document presentation modification can modify the data presented in the timeline that the operator would like to have present on a timeline main menu, such as to facilitate review and interaction with the timeline. The algorithm then proceeds to 912.

At 912, it is determined whether to change settings. In one example embodiment, the timeline can include control settings that allow the project manager to send prompts or other suitable functions can be used to determine what the project status is. If it is determined that a setting is to be changed, the algorithm proceed to 914, otherwise the algorithm proceeds to 918.

At 914, an operator interface settings control is generated. In one example embodiment, the operator interface settings control can be generated at a main menu and can include a predetermined settings and available alternate settings or controls. The algorithm then proceeds to 916.

At 916, the timeline document presentation is modified to reflect the modified settings. The algorithm then proceeds to 918.

At 918, it is determined whether to schedule a video or virtual service provider visit. If it is determined that a video or virtual visit is selected, the algorithm proceeds to 920, otherwise the algorithm returns to 902.

At 920, a link for an operator interface for a service provider, project personnel or project manager to engage in a video or virtual visit is generated. In one example embodiment, the link can include identifying information for a specific service provider, and can include additional authentication, security, scheduling or other suitable functionality. The algorithm then proceeds to 922.

At 922, the video document presentation is modified. In one example embodiment, the video document presentation can include one or more operator controls or presentation processing components that are specific to the selected service provider, project personnel or project manager, such as to include information associated with that service provider, the virtual or video visit or other suitable data. The algorithm then returns to 902.

In operation, algorithm 900 modifies project manager document presentation and operator interface processing, such as for use in a system for project collaboration or in other suitable applications. Although algorithm 900 is shown as a flow chart, it can also or alternatively be implemented using a state diagram, a ladder diagram, object oriented programming or other suitable programming paradigms, on one or more special purpose processors or in other suitable manners

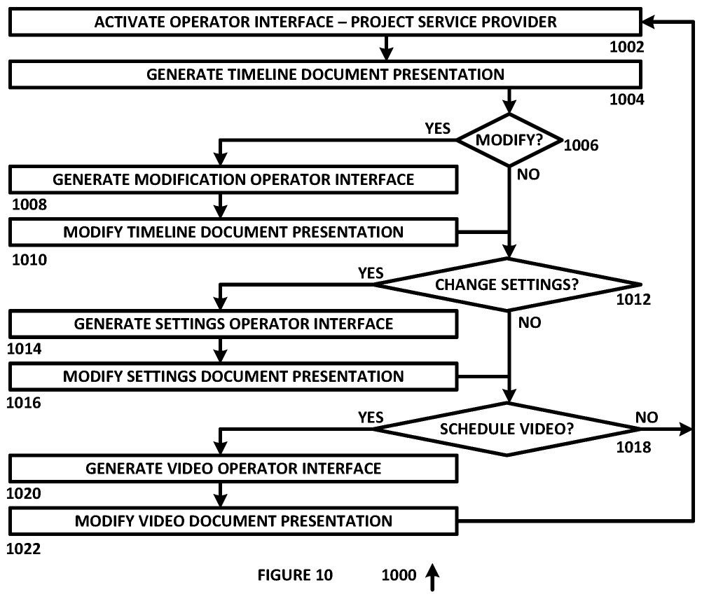

FIG. 10 is a diagram of an algorithm 1000 for modifying project service provider document presentation and operator interface processing, in accordance with an example embodiment of the present disclosure. Algorithm 1000 can be implemented in hardware or a suitable combination of hardware and software.

Algorithm 1000 begins at 1002, where an operator interface for a project service provider is activated. In one example embodiment, the operator interface can include a main menu with predetermined user interface controls and predetermined data that allow the user to obtain specific information that is of primary importance for the project service provider. The algorithm then proceeds to 1004.

At 1004, a timeline document presentation is generated. In one example embodiment, the timeline document presentation can include only those timeline events that are relevant to the project service provider, such as any event that requires the project service provider to respond, to act or to perform other suitable functions. The algorithm then proceeds to 1006.

At 1006, it is determined whether a command has been received to modify the timeline. In one example embodiment, the command can be used to modify a timeline presentation, a timeline operator control or other suitable modifications. If it is determined that a modification is required, the algorithm proceeds to 1008, otherwise the algorithm proceeds to 1012.

At 1008, an operator interface modification control is generated. In one example embodiment, the operator interface modification control can add a control that the operator would like to have present on a timeline main menu, such as to facilitate review and interaction with the timeline. The algorithm then proceeds to 1010.

At 1010, a timeline document presentation is modified. In one example embodiment, the timeline document presentation modification can modify the data presented in the timeline that the operator would like to have present on a timeline main menu, such as to facilitate review and interaction with the timeline. The algorithm then proceeds to 1012.

At 1012, it is determined whether to change settings. In one example embodiment, the timeline can include control settings that allow the project service provider to obtain information from project personnel, to perform services and to provide information regarding the services to the project personnel or project manager, such as test results. If it is determined that a setting is to be changed, the algorithm proceed to 1014, otherwise the algorithm proceeds to 1018.

At 1014, an operator interface settings control is generated. In one example embodiment, the operator interface settings control can be generated at a main menu and can include a predetermined settings and available alternate settings or controls. The algorithm then proceeds to 1016.

At 1016, the timeline document presentation is modified to reflect the modified settings. The algorithm then proceeds to 1018.

At 1018, it is determined whether to schedule a video or virtual service provider visit. If it is determined that a video or virtual visit is selected, the algorithm proceeds to 1020, otherwise the algorithm returns to 1002.

At 1020, a link for an operator interface for a service provider, project personnel or project manager to engage in a video or virtual visit is generated. In one example embodiment, the link can include identifying information for a specific service provider, and can include additional authentication, security, scheduling or other suitable functionality. The algorithm then proceeds to 1022.

At 1022, the video document presentation is modified. In one example embodiment, the video document presentation can include one or more operator controls or presentation processing components that are specific to the selected service provider, project personnel or project manager, such as to include information associated with that service provider, the virtual or video visit or other suitable data. The algorithm then returns to 1002.

In operation, algorithm 1000 modifies project service provider document presentation and operator interface processing, such as for use in a system for project collaboration or in other suitable applications. Although algorithm 1000 is shown as a flow chart, it can also or alternatively be implemented using a state diagram, a ladder diagram, object oriented programming or other suitable programming paradigms, on one or more special purpose processors or in other suitable manners.

The present disclosure includes a system for operator interface processing for collaboration with a trusted circle of project personnel that includes a project manager system operating on a processor and which is configured to select one or more predetermined user interface controls for a project manager and to generate the project manager user interface controls at a main menu of a project manager operator interface. A project service provider system operating on the processor is configured to select one or more predetermined user interface controls for a project service provider to generate the project service provider user interface controls at a main menu of a project service provider operator interface. A project personnel system operating on the processor is configured to select one or more predetermined user interface controls for project personnel and to generate the project personnel user interface controls at a main menu of a project personnel operator interface. The project manager user interface controls, the project service provider user interface controls and the project personnel user interface controls are different from each other.

In other example embodiments, the system can include the project manager system configured to select the project manager user interface controls from a project manager user interface control template, the project service provider system configured to select the project service provider user interface controls from a project service provider user interface control template, the project personnel system configured to select the project personnel user interface controls from a project personnel user interface control template, the project manager system configured to select the project manager user interface controls from a project manager user interface control template that includes one or more project service provider status user interface controls and one or more project personnel status user interface controls, the project service provider system configured to select the project service provider user interface controls from a project service provider user interface control template that includes one or more project manager status user interface controls and one or more project personnel status user interface controls, the project personnel system configured to select the project personnel user interface controls from a project personnel user interface control template that includes one or more project manager status user interface controls and one or more project service provider status user interface controls, the project personnel system configured to select the project personnel user interface controls from a project personnel user interface control template as a function of project manager status data and project service provider status data, or the project personnel system configured to select the project personnel user interface controls from a project personnel user interface control template as a function of project manager workflow data and project service provider workflow data.

In another embodiment, a system for presentation processing for documents for collaboration between project personnel, project manager and project service providers is disclosed. The system includes a project manager document controller operating on a processor and configured to select one or more predetermined document controls for a project manager and to generate the project manager document controls at a main menu of a project manager document interface. A project service provider document controller operating on the processor is configured to select one or more predetermined document controls for a project service provider to generate the project service provider document controls at a main menu of a project service provider document interface. A project personnel document controller operating on a processor is configured to select one or more predetermined document controls for project personnel and to generate the project personnel document controls at a main menu of a project personnel document interface. The project manager document controls, the project service provider document controls and the project personnel document controls are different from each other.

In other example embodiments, the project manager document controller can be configured to select the project manager document controls from a project manager document control template, the project service provider document controller can be configured to select the project service provider document controls from a project service provider document control template, the project personnel document controller can be configured to select the project personnel document controls from a project personnel document control template, the project manager document controller can be configured to select the project manager document controls from a project manager document control template that includes one or more project service provider document status controls and one or more project personnel document status controls, the project service provider document controller can be configured to select the project service provider document controls from a project service provider document control template that includes one or more project manager document status controls and one or more project personnel document status controls, the project personnel document controller can be configured to select the project personnel document controls from a project personnel document control template that includes one or more project manager document status controls and one or more project service provider document status controls, the project personnel document controller can be configured to select the project personnel document controls from a project personnel document control template as a function of project manager document status data and project service provider document status data, or the project personnel document controller can be configured to select the project personnel document controls from a project personnel document control template as a function of project manager document workflow data and project service provider document workflow data.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for operator interface processing for collaboration with a trusted circle of project personnel, comprising:
a project manager system operating on a processor and configured to select one or more predetermined user interface controls for a project manager and to generate the project manager user interface controls at a main menu of a project manager operator interface;
a project service provider system operating on the processor and configured to select one or more predetermined user interface controls for a project service provider to generate the project service provider user interface controls at a main menu of a project service provider operator interface;
a project personnel system operating on the processor and configured to select one or more predetermined user interface controls for project personnel and to generate the project personnel user interface controls at a main menu of a project personnel operator interface; and
wherein the project manager user interface controls, the project service provider user interface controls and the project personnel user interface controls are different from each other.

2. The system of claim 1 wherein the project manager system selects the project manager user interface controls from a project manager user interface control template.

3. The system of claim 1 wherein the project service provider system selects the project service provider user interface controls from a project service provider user interface control template.

4. The system of claim 1 wherein the project personnel system selects the project personnel user interface controls from a project personnel user interface control template.

5. The system of claim 1 wherein the project manager system selects the project manager user interface controls from a project manager user interface control template that includes one or more project service provider status user interface controls and one or more project personnel status user interface controls.

6. The system of claim 1 wherein the project service provider system selects the project service provider user interface controls from a project service provider user interface control template that includes one or more project manager status user interface controls and one or more project personnel status user interface controls.

7. The system of claim 1 wherein the project personnel system selects the project personnel user interface controls from a project personnel user interface control template that includes one or more project manager status user interface controls and one or more project service provider status user interface controls.

8. The system of claim 1 wherein the project personnel system selects the project personnel user interface controls from a project personnel user interface control template as a function of project manager status data and project service provider status data.

9. The system of claim 1 wherein the project personnel system selects the project personnel user interface controls from a project personnel user interface control template as a function of project manager workflow data and project service provider workflow data.

10. A system for presentation processing for documents for collaboration between project personnel, project manager and project service providers, comprising:
a project manager document controller operating on a processor and configured to select one or more predetermined document controls for a project manager and to generate the project manager document controls at a main menu of a project manager document interface;
a project service provider document controller operating on the processor and configured to select one or more predetermined document controls for a project service provider to generate the project service provider document controls at a main menu of a project service provider document interface;
a project personnel document controller operating on a processor and configured to select one or more predetermined document controls for project personnel and to generate the project personnel document controls at a main menu of a project personnel document interface; and
wherein the project manager document controls, the project service provider document controls and the project personnel document controls are different from each other.

11. The system of claim 10 wherein the project manager document controller selects the project manager document controls from a project manager document control template.

12. The system of claim 10 wherein the project service provider document controller selects the project service provider document controls from a project service provider document control template.

13. The system of claim 10 wherein the project personnel document controller selects the project personnel document controls from a project personnel document control template.

14. The system of claim 10 wherein the project manager document controller selects the project manager document controls from a project manager document control template that includes one or more project service provider document status controls and one or more project personnel document status controls.

15. The system of claim 10 wherein the project service provider document controller selects the project service provider document controls from a project service provider document control template that includes one or more project manager document status controls and one or more project personnel document status controls.

16. The system of claim 10 wherein the project personnel document controller selects the project personnel document controls from a project personnel document control template that includes one or more project manager document status controls and one or more project service provider document status controls.

17. The system of claim 10 wherein the project personnel document controller selects the project personnel document controls from a project personnel document control template as a function of project manager document status data and project service provider document status data.

18. The system of claim 10 wherein the project personnel document controller selects the project personnel document controls from a project personnel document control template as a function of project manager document workflow data and project service provider document workflow data.
